(19) United States
(12) Patent Application Publication
(10) Pub. No.: US 2015/0169713 A1
(43) Pub. Date: Jun. 18, 2015

(54) PLUG-IN ARCHITECTURE FOR USING EXTERNAL TOOLS WITH ETL PRODUCTS

(71) Applicant: Alexander Ocher, San Jose (CA)

(72) Inventor: Alexander Ocher, San Jose (CA)

(21) Appl. No.: 14/133,014

(22) Filed: Dec. 18, 2013

(51) Int. Cl. G06F 17/30

(52) U.S. Cl. CPC G06F 17/30563

(57) ABSTRACT

According to some embodiments, a method and an apparatus of interfacing an external data processing tool (“DPT”) with an Extract, Transform and Load (“ETL”) product comprise defining a DPT to ETL schema and defining an ETL to DPT schema. The DPT may be called via a generic external transform using a plurality of DPT parameters. Data may be transmitted to the DPT, via a processor, based on the ETL to DPT schema and the DPT parameters.

### BACKGROUND

Conventional extract, transform, and load (“ETL”) products relate to the extraction of data from a source, transforming the data to fit an operational need, and/or loading the transformed data into a target (e.g., a database, data warehouse, an application, a flat file, etc.). Each ETL product may use predefined sources and predefined targets and a set of related predefined transforms.

Adding new sources, targets and transforms to conventional ETL products may be extremely difficult and expensive for an end user since adding new sources, targets and transforms may require a significant development effort by ETL product vendors. Thus, it may be extremely difficult, and expensive, to integrate the ETL product with sources and targets that are not natively supported by the ETL product, especially sources and targets that provide proprietary functions (e.g., web spidering, screen-scraping tools, and confidential algorithmic searches or sorts).

Furthermore, when dealing with large amounts of data (e.g., an in-memory database that comprises a large quantity of data), conventional ETL products may experience a degradation in performance due to processing problems and memory overflows which may be beyond the control of a developer to change.

### BRIEF DESCRIPTION OF THE DRAWINGS

FIG. 1 illustrates a method according to some embodiments.

FIG. 2 illustrates a system according to some embodiments.

FIG. 3 illustrates an ETL to DPT schema according to some embodiments.

FIG. 4 illustrates a DPT to ETL schema according to some embodiments.

FIG. 5 illustrates an apparatus according to some embodiments.

### DETAILED DESCRIPTION

The present embodiments relate to a method, apparatus and system to integrate an external data processing tool (“DPT”) with an existing ETL product by passing an input schema and an output schema to the DPT from the ETL product and by using a generic external transform from the ETL product to the DPT. In some embodiments, multiple elements of the ETL product may be replaced by one or more DPT tools which, in certain cases, may enable the ETL tool to act as a composer to define a desired processing logic and to coordinate execution of multiple DPT tools.

A schema may comprise a structure, described in a computer related language that defines how data is organized in a data file or a database. Transforms performed by a DPT may require an input schema to define a format of untransformed data (e.g., how the data looks prior to being transformed) and an output schema to define a format of transformed data (e.g., how the data looks after it is transformed).

While some conventional ETL products may provide an ability to call a command line executable, such as a system call, the conventional command line executables don't allow an ETL product to pass an input schema and an output schema. However, the present embodiments may allow an ETL product to extend transforms to allow third-party data processing tools (and their associated transforms) to be integrated with an ETL product such as, but not limited to, reader, loader, merge, pivot and other typical ETL transform operations.

Since an ETL product may receive files from different sources that, although comply with a same standard, may be using slightly different implementations or different versions of a same standard (e.g., HL7 version 2 and 3), the use of different DPTs may allow the ETL product to read data and then process the data in any required way by calling external tools from an ETL transform. And, by using a generic external transform, customers may be able to create their own transformations.

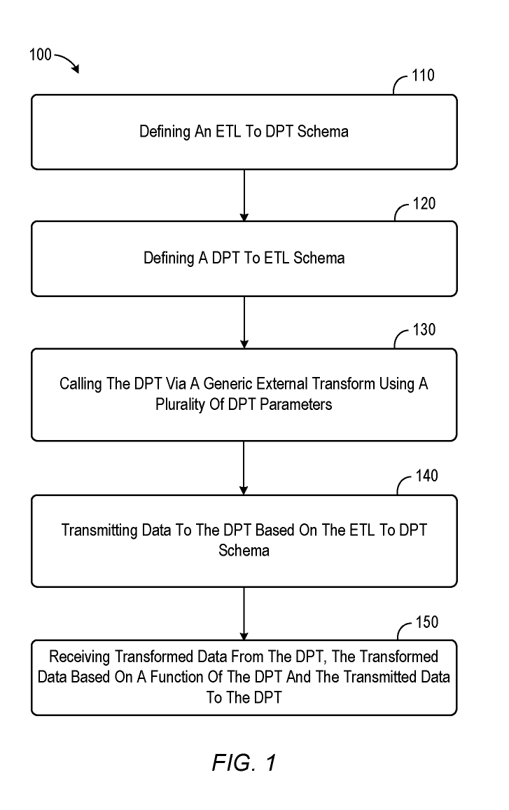

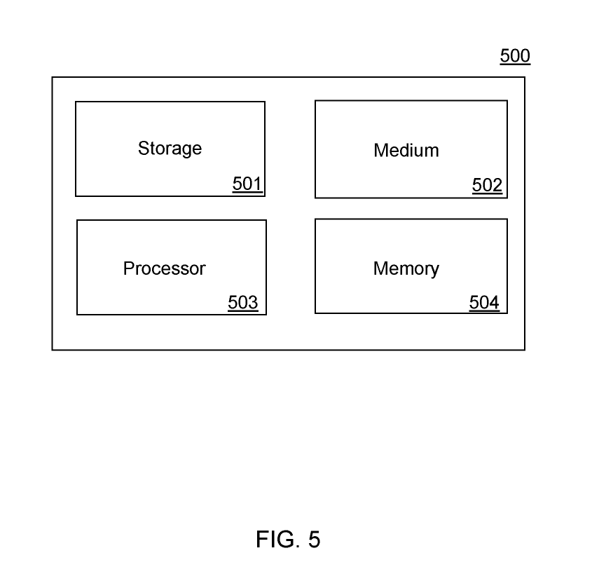

Referring now to FIG. 1, an embodiment of a method 100 is illustrated. The method may relate to interfacing a DPT with an ETL product such as an ETL software tool. The method 100 may be embodied on a non-transitory computer-readable medium. Furthermore, the method 100 may be performed by an apparatus such as, but not limited to, the apparatus of FIG. 5.

At 110, an ETL to DPT schema is defined. The ETL to DPT schema may define a desired input schema to the DPT.

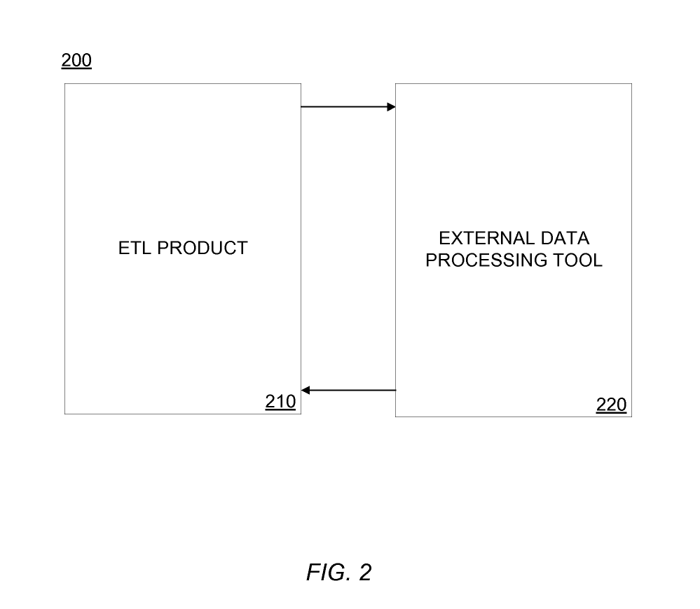

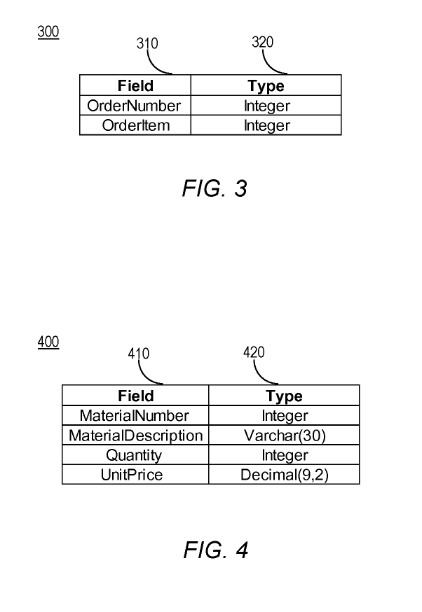

For illustrative purposes, and to aid in understanding features of the specification, an example will be introduced. This example is not intended to limit the scope of the claims. Now referring to FIG. 2, an embodiment of a system 200 is illustrated. System 200 comprises an ETL product 210 in communication with a DPT 220. An ETL to DPT schema may be created that defines the data sent to the DPT 220 from the ETL product 210. In this example, the ETL product may send data comprising two fields, one labeled “OrderNumber” of type Integer and one labeled “OrderItem” of type integer. For example, and now referring to FIG. 3, a ETL to DPT schema 400 is illustrated according to some embodiments. The ETL to DPT schema of FIG. 3. may comprise fields that indicate a field name 310 and a field type 320. As illustrated in FIG. 3, the ETL to DPT schema 300 may comprise the following:

OrderNumber Integer

OrderItem Integer

In some embodiments, batch files (e.g., Windows) or scripts (e.g., UNIX) may convert schema files into a format expected by DTP. For example, the ETL to DPT schema may be converted to use pre-defined names that may be understood by the DTP such as the following COBOL format:

ORDNUM 99999

ORDLINE 99999

Referring back to FIG. 1, at 120, a DPT to ETL schema is defined. The DPT to ETL schema may define a desired output schema from the DPT (e.g., to be received at the ETL product). The DPT to ETL schema may be based on a user's modification of the ETL to DPT schema, or may be automatically changed based on a type of transform being performed by the DPT. The ETL product may receive a DPT to ETL schema. In some embodiments, the DPT to ETL schema may be received from the DPT 220. The ETL product 210, such as, but not limited to, SAP's Data Services, may use one or more DPTs in a same dataflow/job, such as (1) an HL7-to-XML converter as a reader, (2) an external sorter, and/or (3) a proprietary COBOL program as a loader, with no additional development required.

In some embodiments, the DPT to ETL schema comprises a fixed schema, however, in other embodiments the DPT to ETL schema may comprise a dynamically changing schema. The DPT to ETL schema and the ETL to DPT schema may function as input and output schemas, respectively, for an external transform.

Continuing with the above example, the DPT to ETL schema may define what the ETL product 210 expects to receive from DTP 220. In this example, the DPT 220 may comprise a proprietary processing system that performs a lookup based on received data. In this example, the DPT 220 may return data after the DPT 220 transforms the data. The transformed data may comprise four fields. The first labeled “MaterialNumber” of type Integer, the second labeled “MaterialDescription” of type varchar, the third labeled “Quantity” of type integer, and the fourth labeled “UnitPrice” of type decimal. For example, and now referring to FIG. 4, a DPT to ETL schema 400 is illustrated according to some embodiments. The DPT to ETL schema of FIG. 4. may comprise fields that indicate a field name 410 and a field type 420. As illustrated in FIG. 4, the DPT to ETL schema 400 may comprise the following:

MaterialNumber Integer

MaterialDescription Varchar(30)

Quantity Integer

UnitPrice Decimal(9,2)

Referring back to FIG. 1, at 130 the DPT may be called via a generic external transform using a plurality of DPT parameters.

At 130 the DPT is called via an external transform using a plurality of DPT parameters. The ETL product may comprise a transform to call a DPT. The generic external transform may be used for any DPT such as DPTs for transformations, reading and loading. Thus, when the generic external transform relates to a transformation, the generic external transform may use a input schema and an output schema. However, when the generic external transform relates to a reader (e.g., reading) the generic external transform may use an output schema. Similarly, when the generic external transform relates to a loader (e.g. storing data in a target), the generic external transform may use an input schema.

In practice, a user, via an ETL product, may select a generic external transform to interface with one or more DPTs. In some embodiments, the generic external transform may comprise fields that specify how to call the DPT from the ETL product. For example, the generic external transform may specify a command line associated with DPT, a name of an ETL to DPT schema, a name of a metadata conversion script, a mode, an indication associated with whether input and output data files will be kept or deleted.

A DPT may execute programs, either supplied by an operating system (e.g., cut, copy/move, head/tail, etc.) or the DPT may execute a script and/or batch file. The generic external transform may further comprise parameters associated with the command line such as an executable to initiate a transformation associated with the DPT and other associated command parameters. The executable may comprise a command such as, for example, cut, sort, read, load, any external program, script or batch file, an executable for a Health Level Seven International (“HL7”) to HTML converter, an Excel loader, or any other suitable executable.

The metadata conversion script (e.g., a UNIX script, Windows batch file, binary executable, etc.) may comprise a script that is called to translate metadata into a format that is understood by the DPT and each schema may be associated with a different script to translate metadata. In some embodiments, the ETL to DPT schema and the DPT to ETL schema may comprise text files that include an option for the user to specify a name of a conversion script to convert these files into a format suitable for the DTP.

The mode field may indicate a type of communication. For example, the mode field may indicate whether the command line executable is expecting an input file or if the executable relates to a UNIX filter program that reads from its standard input and writes to its standard output. Communication with the ETL product may occur via files or connections such as IPC (socket, etc.) or shared memory or Web service. In some embodiments, the ETL product may be dynamically linked to a library at run-time (LoadLibrary) to load information associated with the DPT.

In some embodiments, existing transforms may be modified to include fields associated with a DPT (e.g., an external tool instead of an on-board) tool. While a generic external transform may be a better choice when calling a DPT that performs a function that is different from on-board transforms such as, but not limited to, accessing a legacy computer system via a proprietary interface, modifying existing transforms may be suited for DPTs that perform similar functions as an on-board transform. For example, to access an external sorting program, a ETL product user may use an existing query transform and specify a new executable for the external source which may make it easier to switch between eternal and built in functionality as well as presenting other users of a dataflow with a familiar concept. Using an existing transform may also be beneficial when using an external reader or loader. For example, an existing XML reader transform may be modified to use an external tool that outputs XML data. Another example may comprise modifying an existing flat file reader to use an external tool that expects text rows as an input. This may allow a user to integrate a variety of ETL products with a variety of external tools to support additional sources, transformations and targets with minimal programming and no need to modify the source code of the existing ETL product. Some embodiments may also allow for temporary file handling for input and output data files for a DPT as well as provide monitoring, statistics and logging for end-to-end data processing.

For example, when a conventional system call, such as exec( ) function, is used, there may be no smooth end-to-end monitoring and visibility since each step may have to be individually monitored. However, in the present embodiments, when calling an external program (e.g., a sorting program), a number of input records, a number of output records and a total processing time will be displayed. In addition, standard functionality such as row-level debugging may be available and any errors from the DPT may be recorded in the ETL job log file.

In some embodiments, the DPT may receive both the ETL to DPT schema and the DPT to ETL schema in response to a user initiating a generic external transform. In other embodiments, the ETL to DPT schema and the DPT to ETL schema may be transmitted to a DPT tool via an Application Programming Interface (“API”). In some embodiments, the DPT may receive the schemas from the ETL product and the ETL product may simply receive output data from the DPT.

The parameters used in calling a generic external transform may comprise hard-coded parameters or in some embodiments, the command line associated with the DPT may comprise dynamic parameters. For example, the names of the schemas used by the generic external transform may be fixed, such as infile.txt and outfile.txt, or they can be created as unique names and optionally deleted, for example, cmdtool $$1 $2, where $$1 means to create an input file with a unique name using data from the ETL product and to keep the input file and to create an output file with a unique name using the data from DTP tool and delete the output file after ETL tool finishes reading and processing the data. Each file name may be provided by the ETL product.

Continuing with the above example and again referring to FIG. 2, a user may desire to use the ETL product 210 to interface with the DPT 220 to use a proprietary database lookup. The user may select the generic external transform and enter information associated with the DPT 220 such as, but not limited to, an executable as well as other associated parameters, such as for example “cut-f1,6-d′,” to indicate that the output should contain only the first and sixth fields. The generic external transform may further include a field that comprises a name of an output file. In other words, the ETL product may call an executable associated with the DPT that is provided in a field in the generic external transform and pass any required parameters to it. In some embodiments, each existing transform within the ETL product may comprise an external field for interfacing with a DPT and a table of fields (e.g., metadata) to pass to the DPT. In this way, each type of existing transform may be able to call a generic external transform located at a DPT.

At 140 data is transmitted to the DPT based on the ETL to DPT schema. The data may comprise the data to be transformed by the DPT. The transmitted data may be formatted based on the ETL to DPT schema.

Continuing with the above example, data to be transformed is transmitted from the ETL product to the DPT based on the ETL to DPT schema and the executable (and associated parameters).

At 150, transformed data is received from the DPT, the transformed data being based on a function of the DPT and the transmitted data to the DPT.

Continuing with the above example, the data transmitted to the DPT is transformed based on the proprietary database lookup associated with the DPT and the transformed data is transmitted to the ETL product using the format of the DPT to ETL schema.

The aforementioned embodiments may facilitate the calling of external tools from an ETL transform within an ETL product. The aforementioned embodiments may allow a user to assemble and coordinate various third-party tools to interface with an existing ETL product that may be performed faster than conventional methods of having a developer create new on-board ETL transforms as well as being performed without disruption to the existing ETL product. For example, replacing one external function such as reader with a different reader can be accomplished without disrupting the ETL product. This may be advantageous over conventional systems since a user or a company may not have to be locked into a single vendor or proprietary technology.

Now referring to FIG. 5, an embodiment of an apparatus 500 is illustrated. In some embodiments, the apparatus 500 may be associated with an ETL product.

The apparatus 500 may comprise a storage device 501, a medium 502, a processor 503, and a memory 504. According to some embodiments, the apparatus 500 may further comprise a digital display port, such as a port adapted to be coupled to a digital computer monitor, television, portable display screen, or the like.

The medium 502 may comprise any computer-readable medium that may store processor-executable instructions to be executed by the processor 503. For example, the medium 502 may comprise a non-transitory tangible medium such as, but not limited to, a compact disk, a digital video disk, flash memory, optical storage, random access memory, read only memory, or magnetic media.

A program may be stored on the medium 502 in a compressed, uncompiled and/or encrypted format. The program may furthermore include other program elements, such as an operating system, a database management system, and/or device drivers used by the processor 503 to interface with peripheral devices.

The processor 503 may include or otherwise be associated with dedicated registers, stacks, queues, etc. that are used to execute program code and/or one or more of these elements may be shared there between. In some embodiments, the processor 503 may comprise an integrated circuit. In some embodiments, the processor 503 may comprise circuitry to perform a method such as, but not limited to, the method described with respect to FIG. 1.

The processor 503 communicates with the storage device 501. The storage device 501 may comprise any appropriate information storage device, including combinations of magnetic storage devices (e.g., a hard disk drive), optical storage devices, flash drives, and/or semiconductor memory devices. The storage device 501 stores a program for controlling the processor 503. The processor 503 performs instructions of the program, and thereby operates in accordance with any of the embodiments described herein.

The main memory 504 may comprise any type of memory for storing data, such as, but not limited to, a flash driver, a Secure Digital (SD) card, a micro SD card, a Single Data Rate Random Access Memory (SDR-RAM), a Double Data Rate Random Access Memory (DDR-RAM), or a Programmable Read Only Memory (PROM). The main memory 504 may comprise a plurality of memory modules.

As used herein, information may be “received” by or “transmitted” to, for example: (i) the apparatus 500 from another device; or (ii) a software application or module within the apparatus 500 from another software application, module, or any other source.

In some embodiments, the storage device 501 stores a database (e.g., including information associated with ETL transforms). Note that the database described herein is only an example, and additional and/or different information may be stored therein. Moreover, various databases might be split or combined in accordance with any of the embodiments described herein. In some embodiments, an external database may be used.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method of interfacing an external data processing tool (“DPT”) with a Extract, Transform and Load (“ETL”) product, the method comprising:
defining an ETL to DPT schema;
defining a DPT to ETL schema;
calling the DPT via a generic external transform using a plurality of DPT parameters; and
transmitting data to the DPT, via a processor, based on the ETL to DPT schema and the DPT parameters.

2. The method of claim 1, further comprising:
receiving transformed data from the DPT, the transformed data based on a function of the DPT and the transmitted data to the DPT.

3. The method of claim 1, wherein the DPT parameters comprise:
a command line associated with the DPT;
a name of the ETL to DPT schema file;
a name of a metadata conversion script associated with the ETL to DPT schema file;
a mode;
a name of the DTP to ETL schema file; and
a name of a metadata conversion script associated with the DPT to ETL schema file.

4. The method of claim 3, wherein the parameters comprise hard-coded parameters.

5. The method of claim 3, wherein the command line associated with the DPT comprises:
dynamic parameters.

6. The method of claim 3, wherein the mode comprises a type of communication.

7. The method of claim 6, wherein the type of communication comprises (i) a file (ii) a filter, (iii) socket connection, or (iv) shared memory.

8. A non-transitory computer-readable medium comprising instructions that when executed by a processor perform a method of interfacing an external data processing tool (“DPT”) with a Extract, Transform and Load (“ETL”) product, the method comprising:
defining an ETL to DPT schema;
defining a DPT to ETL schema;
calling the DPT via a generic external transform using a plurality of DPT parameters; and
transmitting data to the DPT, via a processor, based on the ETL to DPT schema and the DPT parameters.

9. The medium of claim 8, further comprising:
receiving transformed data from the DPT, the transformed data based on a function of the DPT and the transmitted data to the DPT.

10. The medium of claim 8, wherein the DPT parameters comprise:
a command line associated with the DPT;
a name of the ETL to DPT schema file;
a name of a metadata conversion script associated with the ETL to DPT schema file;
a mode;
a name of the DTP to ETL schema file; and
a name of a metadata conversion script associated with the DPT to ETL schema file.

11. The medium of claim 10, wherein the command line associated with the DPT comprises:
hard-coded parameters.

12. The medium of claim 10, wherein the command line associated with the DPT comprises:
dynamic parameters.

13. The medium of claim 10, wherein the mode comprises a type of communication.

14. The medium of claim 13, wherein the type of communication comprises (i) a file (ii) a filter, (iii) socket connection, or (iv) shared memory.

15. An apparatus comprising:
a processor; and
a non-transitory computer-readable medium comprising instructions that when executed by a processor perform a method of interfacing an external data processing tool (“DPT”) with a Extract, Transform and Load (“ETL”) product, the method comprising:
defining an ETL to DPT schema;
defining a DPT to ETL schema;
calling the DPT via a generic external transform using a plurality of DPT parameters; and
transmitting data to the DPT, via a processor, based on the ETL to DPT schema and the DPT parameters.

16. The apparatus of claim 15, wherein the method further comprises:
receiving transformed data from the DPT, the transformed data based on a function of the DPT and the transmitted data to the DPT.

17. The medium of claim 15, wherein the DPT parameters comprise:
a command line associated the DPT;
a name of the ETL to DPT schema file;
a name of a metadata conversion script associated with the ETL to DPT schema file;
a mode;
a name of the DTP to ETL schema file; and
a name of a metadata conversion script associated with the DPT to ETL schema file.

18. The apparatus of claim 17, wherein the command line associated with the DPT comprises:
hard-coded parameters.

19. The apparatus of claim 17, wherein the command line associated with the DPT comprises:
dynamic parameters.

20. The apparatus of claim 15, wherein a number of input records, a number of output records and a total processing time will be displayed in response to calling the DPT via a generic external transform.
